(19) United States
(12) Patent Application Publication
(10) Pub. No.: US 2013/0188074 A1
(43) Pub. Date: Jul. 25, 2013

(54) IMAGE PICKUP UNIT, COLOR CORRECTION METHOD, AND COLOR CORRECTION PROGRAM

(71) Applicant: Sony Corporation, Tokyo (JP)

(72) Inventor: Kiyotaka Nakabayashi, Saitama (JP)

(73) Assignee: Sony Corporation, Tokyo (JP)

(21) Appl. No.: 13/739,072

(22) Filed: Jan. 11, 2013

(30) Foreign Application Priority Data
Jan. 19, 2012 (JP) 2012-009231

(51) Int. Cl. H04N 9/73

(52) U.S. Cl. CPC H04N 9/735
USPC 348/223.1

(57) ABSTRACT

An image pickup unit includes: an image pickup device outputting an image signal based on incident object light; a dimming device adjusting a light amount of object light incident to the image pickup device; a color correction section adjusting color balance of the image signal; and a control section controlling the color correction section to be switched from one of a first adjustment mode and a second adjustment mode to the other, the first adjustment mode automatically adjusting the color balance following variations in color temperature of a light source, the second adjustment mode adjusting the color balance without following variations in color temperature of the light source. The control section controls a light amount adjustment value by the dimming device at a fixed value, when the color correction section is switched to the second adjustment mode.

### BACKGROUND

The present disclosure relates to an image pickup unit, for example, a digital still camera or a video camera, and a color correction method and a color correction program which are executed to control color balance (white balance) in such an image pickup unit.

Image pickup units such as digital still cameras and video cameras include a white balance adjustment function allowing colors of an object to be correctly reproduced based on a light source (refer to Japanese Unexamined Patent Application Publication No. 2006-319514). Methods of adjusting white balance include a method of performing AWB (auto white balance) control in which white balance is automatically adjusted following variations in color temperature of a light source, and a method of performing fixed preset control in which a white balance adjustment value is fixed at a predetermined adjustment value. In the fixed preset control, for example, white balance adjustment values (gains) suitable for respective light sources such as sunlight and a fluorescent lamp are determined in advance. Then, when a user selects a light source, the white balance adjustment value is fixed at an adjustment value suitable for the selected light source.

### SUMMARY

A typical image pickup unit such as a digital still camera includes a diaphragm (an iris diaphragm) mechanically adjusting a light amount of object light to adjust exposure. As an alternative to such a mechanical diaphragm, for example, it is considered to use a liquid crystal dimming device electrically switching light transmittance to any one of a plurality of states with use of a liquid crystal device. Even if such a liquid crystal dimming device is used, it is necessary to appropriately adjust white balance. In particular, in the case where fixed preset control is performed, white balance adjustment values are fixed. Therefore, when spectral characteristics vary in the liquid crystal dimming device, a color shift from appropriate white balance occurs.

It is desirable to provide an image pickup unit, a color correction method, and a color correction program which are capable of suppressing a color balance shift even with use of a dimming device.

According to an embodiment of the disclosure, there is provided an image pickup unit including: an image pickup device outputting an image signal based on incident object light; a dimming device adjusting a light amount of object light incident to the image pickup device; a color correction section adjusting color balance of the image signal; and a control section controlling the color correction section to be switched from one of a first adjustment mode and a second adjustment mode to the other, the first adjustment mode automatically adjusting the color balance following variations in color temperature of a light source, the second adjustment mode adjusting the color balance without following variations in color temperature of the light source. The control section controls a light amount adjustment value by the dimming device at a fixed value, when the color correction section is switched to the second adjustment mode.

According to an embodiment of the disclosure, there is provided a color correction method including: adjusting, by a dimming device, a light amount of object light incident to an image pickup device; adjusting, by a color correction section, color balance of an image signal output from the image pickup device; and controlling the color correction section to be switched from one of a first adjustment mode and a second adjustment mode to the other, the first adjustment mode automatically adjusting the color balance following variations in color temperature of a light source, the second adjustment mode adjusting the color balance without following variations in color temperature of the light source. In the controlling of the color correction section, a light amount adjustment value by the dimming device is controlled at a fixed value, when the color correction section is switched into the second adjustment mode.

According to an embodiment of the disclosure, there is provided a color correction program adapted to be executed to implement a method, the method including: adjusting, by a dimming device, a light amount of object light incident to an image pickup device; adjusting, by a color correction section, color balance of an image signal output from the image pickup device; and controlling the color correction section to be switched from one of a first adjustment mode and a second adjustment mode to the other, the first adjustment mode automatically adjusting the color balance following variations in color temperature of a light source, the second adjustment mode adjusting the color balance without following variations in color temperature of the light source. In the controlling of the color correction section, a light amount adjustment value by the dimming device is controlled at a fixed value, when the color correction section is switched into the second adjustment mode.

In the image pickup unit, the color correction method, and the color correction program according to the embodiments of the disclosure, the light amount of object light incident to the image pickup device is adjusted by the dimming device. The color correction section is controlled to be switched from one of the first adjustment mode and the second adjustment mode to the other. In the first adjustment mode, color balance is automatically adjusted following variations in color temperature of the light source, and in the second adjustment mode, color balance is adjusted without following variations in color temperature of the light source. When the color correction section is switched into the second adjustment mode, the light amount adjustment value by the dimming device is controlled at a fixed value.

In the image pickup unit, the color correction method, and the color correction program according to the embodiments of the disclosure, when color balance is adjusted without following variations in color temperature of the light source, the light amount adjustment value by the dimming device is controlled at a fixed value; therefore, a color balance shift is suppressed even with use of the dimming device.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the technology, and are incorporated in and constitute a part of this specification. The drawings illustrate embodiments and, together with the specification, serve to explain the principles of the technology.

FIG. 1 is a block diagram illustrating a configuration example of an image pickup unit according to an embodiment of the disclosure.

FIG. 2 is a sectional view illustrating a configuration example of a liquid crystal ND filter as an example of a dimming device.

FIG. 3 is a flowchart illustrating an example of white balance control.

FIG. 4 is a block diagram illustrating a concept of exposure control.

FIG. 5 is a program diagram illustrating a first example of exposure control.

FIG. 6 is a program diagram illustrating a second example of exposure control.

### DETAILED DESCRIPTION

A preferred embodiment of the disclosure will be described in detail below referring to the accompanying drawings. It is to be noted that description will be given in the following order.

1. Configuration of image pickup unit

2. Specific example of dimming device

3. Specific example of white balance control operation

4. Examples of exposure control

5. Effects

6. Modifications

### [1. Configuration of Image Pickup Unit]

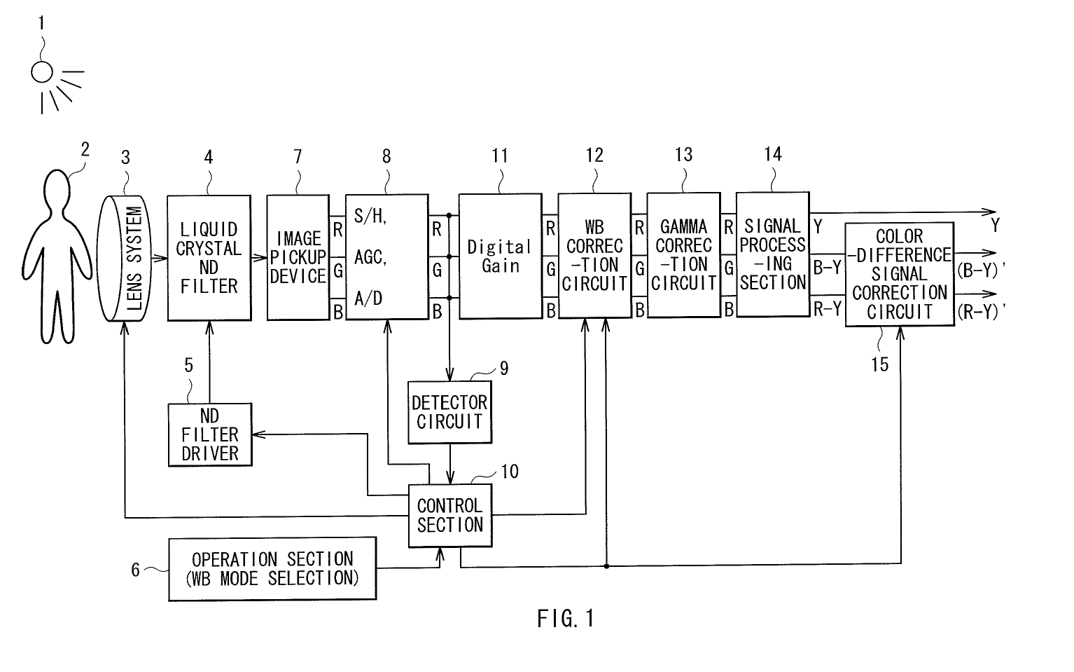

FIG. 1 illustrates a configuration example of an image pickup unit according to an embodiment of the disclosure. The image pickup unit includes a lens system 3, a liquid crystal ND filter 4 as a dimming device, an ND filter driver 5, an operation section 6, an image pickup device 7, a preprocessing circuit 8, a detector circuit 9, a control section 10, a digital gain circuit 11, a WB (white balance) correction circuit 12 as a color correction section, a gamma correction circuit 13, a signal processing section 14, and a color-difference signal correction circuit 15.

The image pickup unit is a digital still camera, a video camera, or the like converting an optical image from an object 2 illuminated by a light source 1 (such as sunlight or a fluorescent lamp) into an electrical image signal by the image pickup device 7. It is to be noted that the image signal obtained in such a manner may be stored in a semiconductor recording medium (not illustrated), or may be displayed on a display unit such as a liquid crystal display unit (not illustrated).

The lens system 3 allows object light to converge on an image pickup plane of the image pickup device 7. The lens system 3 includes a diaphragm (an iris diaphragm) mechanically adjusting a light amount of the object light.

The liquid crystal ND filter 4 adjusts the light amount of the object light incident to the image pickup device 7, and is an ND (Neutral Density) filter allowing light transmittance to be electrically switched into any one of a plurality of states. The state of the liquid crystal ND filter 4 is controlled by the control section 10 through the ND filter driver 5. It is to be noted that FIG. 1 illustrates an example in which the liquid crystal ND filter 4 is disposed in an optical path between the lens system 3 and the image pickup device 7; however, the position of the liquid crystal ND filter 4 is not limited thereto, and the liquid crystal ND filter 4 may be disposed in, for example, an optical path in the lens system 3.

The image pickup device 7 is configured of a solid-state image pickup device such as a CMOS (Complementary Metal Oxide Semiconductor) or a CCD (Charge Coupled Device). The image pickup device 7 converts the incident object light into an electrical signal by photoelectric conversion to obtain a three-primary-color signal (R, G, B) as an analog image signal, and then to supply the analog image signal to the preprocessing circuit 8.

The preprocessing circuit 8 performs predetermined signal processing on the analog image signal. The preprocessing circuit 8 includes an S/H (sample/hold) processing circuit, an AGC (Automatic Gain Control) circuit, and an A/D conversion circuit. The preprocessing circuit 8 performs noise removal or signal level adjustment on the analog image signal by these circuits, and then converts the analog image signal into a digital image signal. The digital image signal is input to the control section 10 through the detector circuit 9. Moreover, the digital image signal is also subjected to appropriate luminance correction by the digital gain circuit 11, and then is input to the WB correction circuit 12.

The WB correction circuit 12 adjusts white balance of the image signal. The WB correction circuit 12 adjusts a signal level of each of color components of R, G, and B of the image signal through multiplying each of the color components by an adjustment value (a gain). The white-balance adjusted image signal is input to the gamma correction circuit 13.

The WB correction circuit 12 has, as a white balance adjustment mode, an AWB (auto white balance) mode (a first adjustment mode) in which white balance is automatically adjusted following variations in color temperature of the light source 1. The WB correction circuit 12 also has, as another white balance adjustment mode, a second adjustment mode in which white balance is adjusted without following variations in color temperature of the light source 1. As the second adjustment mode, there are a fixed preset WB mode and a one-push WB mode. Switching from one of the white balance adjustment modes to another is controlled by the control section 10 based on a mode selection operation by the operation section 6.

The fixed preset WB mode is a mode in which a white balance adjustment value (gain) is fixed at one of predetermined adjustment values. In the fixed preset WB mode, for example, white balance adjustment values (gains) suitable for respective possible light sources 1 such as sunlight and a fluorescent lamp are determined in advance, and when a user selects one of light sources 1, the white balance adjustment value is fixed at an adjustment value suitable for the selected light source 1. Moreover, for example, in a specific image shooting mode, the WB correction circuit 12 may be automatically switched into the fixed preset WB mode. For example, in an outdoor image shooting mode, the WB correction circuit 12 may be automatically switched into the fixed preset WB mode in which the white balance adjustment value is fixed at an adjustment value suitable for outdoor.

The one-push WB mode is a manual adjustment mode, and is a mode in which white balance is adjusted while shooting an image of a specific object (for example, a high-luminance image including an achromatic region) for white balance adjustment, and then the adjusted white balance is fixed.

The gamma correction circuit 13 performs gamma correction on the white-balance adjusted image signal. The gamma-corrected image signal is input to the signal processing section 14. The signal processing section 14 converts image signals of R, G, and B into a luminance signal Y and color-difference signals B-Y and R-Y. Color reproduction correction is performed on the color-difference signals B-Y and R-Y in the color-difference signal correction circuit 15. At this time, since a suitable white balance adjustment value (gain) by the above-described WB correction circuit 12 is known, color reproduction correction is performed by an optimum color reproduction correction matrix with use of the suitable white balance adjustment value. The luminance signal Y, and color-difference signals (B-Y)′ and (R-Y)′ output from the color-difference signal correction circuit 15 are final output signals.

When encoding or the like is performed on the final output signals, for example, JPEG-format still image data or MPEG-format moving image data are obtainable. Obtained image data may be stored in a semiconductor recording medium (not illustrated) or the like. Moreover, the final output signals may be displayed on a display unit (not illustrated) such as a liquid crystal display unit.

### [2. Specific Example of Dimming Device]

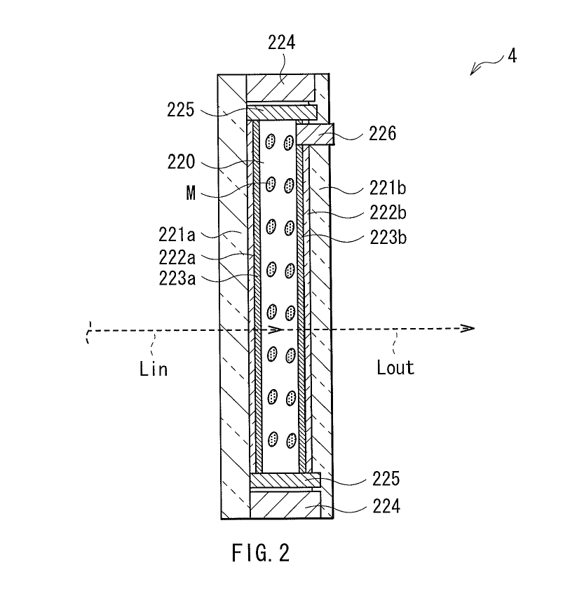

FIG. 2 schematically illustrates a sectional configuration example of the liquid crystal ND filter 4 (a liquid crystal dimming device). The liquid crystal ND filter 4 has a laminate configuration in which a transparent substrate 221a, a transparent electrode 222a, an alignment film 223a, a liquid crystal layer 220, an alignment film 223b, a transparent electrode 222b, and a transparent substrate 221b are laminated in this order of closeness to a side where object light Lin enters toward a side where object light Lout exits. The liquid crystal ND filter 4 further includes a sealing agent 224, a spacer 225, and a sealing section 226.

The liquid crystal layer 220 is a layer containing liquid crystal molecules, and the liquid crystal layer 220 in this embodiment contains predetermined dye molecules (dichroic dye molecules) in addition to the liquid crystal molecules (in FIG. 2, the liquid crystal molecules and the dye molecules are collectively referred to as “molecules M” for the sake of simplification of the drawing). In other words, the liquid crystal ND filter 4 is configured with use of a guest-host (GH) liquid crystal containing a dye (a dichroic dye).

Such GH liquid crystals are broadly classified into a negative type and a positive type by a difference in a long-axis direction of liquid crystal molecules under voltage application. In the positive GH type liquid crystal, the long-axis direction of the liquid crystal molecules is oriented perpendicular to an optical axis under no voltage application (in an OFF state), and is oriented parallel to the optical axis under voltage application (in an ON state). On the other hand, in the negative GH type liquid crystal, the long-axis direction of the liquid crystal molecules is oriented parallel to the optical axis under no voltage application, and is oriented perpendicular to the optical axis under voltage application. The dye molecules here are oriented in the same direction as that of the liquid crystal molecules; therefore, when the positive type liquid crystal is used as a host, light transmittance is relatively low (relatively dark on a light exit side) under no voltage application, and is relatively high (relatively bright on the light exit side) under voltage application. On the other hand, when the negative type liquid crystal is used as a host, light transmittance is relatively high (relatively bright on the light exit side) under no voltage application, and is relatively low (relatively dark on the light exit side) under voltage application. It is to be noted that, in the embodiment, the liquid crystal layer 220 may be made of the positive type liquid crystal or the negative type liquid crystal; however, the liquid crystal layer 220 made of the negative type liquid crystal will be described below as a typical example.

The transparent electrodes 222a and 222b are electrodes applying a voltage (a drive voltage V) to the liquid crystal layer 220, and are made of, for example, indium tin oxide (ITO). It is to be noted that wiring (not illustrated) for electrically connecting with the transparent electrodes 222a and 222b may be disposed, if necessary.

The alignment films 223a and 223b are films allowing each liquid crystal molecule in the liquid crystal layer 220 to be oriented in a desired direction (orientation direction). The alignment films 223a and 223b each are made of, for example, high-polymer material such as polyimide, and are rubbed in a predetermined direction in advance to determine the orientation direction of the liquid crystal molecules.

The transparent substrate 221a is a substrate supporting the transparent electrode 222a and the alignment film 223a, and is positioned on one side of the liquid crystal layer 220 to seal the liquid crystal layer 220. The transparent substrate 221b is a substrate supporting the transparent electrode 222b and the alignment film 223b, and is positioned on the other side of the liquid crystal layer 220 to seal the liquid crystal layer 220. The transparent substrates 221a and 221b each are configured of, for example, a glass substrate.

The sealing agent 224 is a member sealing the molecules M (the liquid crystal molecules and the dye molecules) in the liquid crystal layer 220 from a side surface, and is made of an adhesive such as an epoxy adhesive or an acrylic adhesive. The spacer 225 is a member keeping a cell gap (a thickness) in the liquid crystal layer 220 uniform, and is made of, for example, a predetermined resin material or glass material. The sealing section 226 is an opening allowing the molecules M to be injected into the liquid crystal layer 220, and a section sealing the molecules M in the liquid crystal layer 220 after injecting the molecules M.

### [3. Specific Example of White Balance Control Operation]

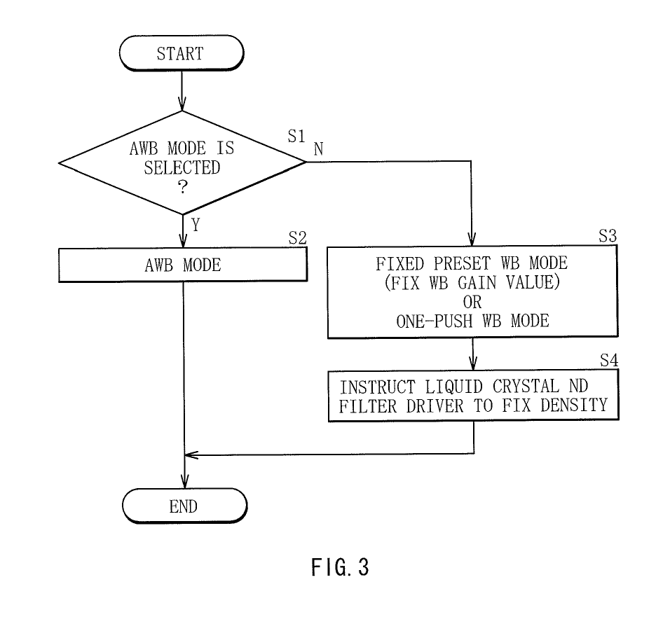

When the light transmittance (density) of the liquid crystal ND filter 4 is varied, the spectral characteristics may vary to cause discoloration. On the other hand, in the fixed preset WB mode or the one-push WB mode, the white balance adjustment value (gain) is fixed; therefore, when the density of the liquid crystal ND filter 4 varies in these modes, a color shift from appropriate white balance occurs. Therefore, the control section 10 performs control as illustrated in FIG. 3 in white balance adjustment to fix the density of the liquid crystal ND filter 4 in modes other than the AWB mode, thereby suppressing the color shift.

The control section 10 monitors instructions for white balance mode selection from the operation section 6. When the AWB mode is selected (step S1; Y), the control section 10 allows the WB correction circuit 12 to operate in the AWB mode (step S2). In the AWB mode, exposure control with use of adjustment by the liquid crystal ND filter 4 is performed.

When the AWB mode is not selected (step S1; N), the control section 10 allows the WB correction circuit 12 to operate in the fixed preset WB mode or the one-push WB mode in response to an instruction from the operation section 6 (step S3). The control section 10 also instructs the ND filter driver 5 to fix the state of the liquid crystal ND filter 4 (step S4). Methods of fixing the state of the liquid crystal ND filter 4 include a method of fixing a light amount (density or light transmittance) adjustment value by the liquid crystal ND filter 4 at an adjustment value at the time of mode switching, and a method of fixing the light amount adjustment value by the liquid crystal ND filter 4 at a predetermined adjustment value. The state of the liquid crystal ND filter 4 is fixed by any one of the methods. Therefore, in the fixed preset WB mode or the one-push WB mode, exposure control is performed without adjustment by the liquid crystal ND filter 4.

### [4. Examples of Exposure Control]

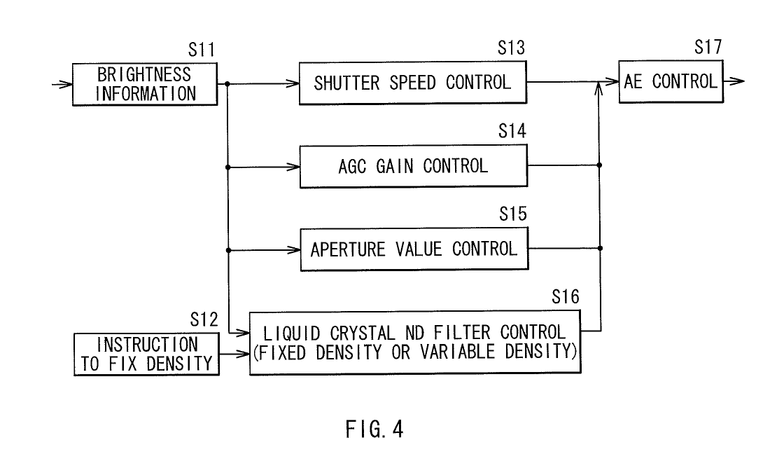

FIG. 4 illustrates a concept of exposure control. The control section 10 obtains luminance information (brightness information) through the detector circuit 9 (step S11), and controls a plurality of exposure adjustment sections (steps S13 to S16) to perform AE (Automatic Exposure) control (step S17). The control section 10 uses the liquid crystal ND filter 4 as a first exposure adjustment section to perform exposure adjustment at the time of image shooting (step S16). Moreover, as second exposure adjustment sections except for the liquid crystal ND filter 4, shutter speed, AGC gain control in the preprocessing circuit 8, and control of an aperture value of the lens system 3 are used (steps S13 to S15). However, as described above, in the modes other than the AWB mode, the density of the liquid crystal ND filter 4 is instructed to be fixed (step S12); therefore, exposure control is performed without using adjustment by the liquid crystal ND filter 4 as the exposure adjustment section. In the AWB mode, exposure control is performed with use of all the exposure adjustment sections.

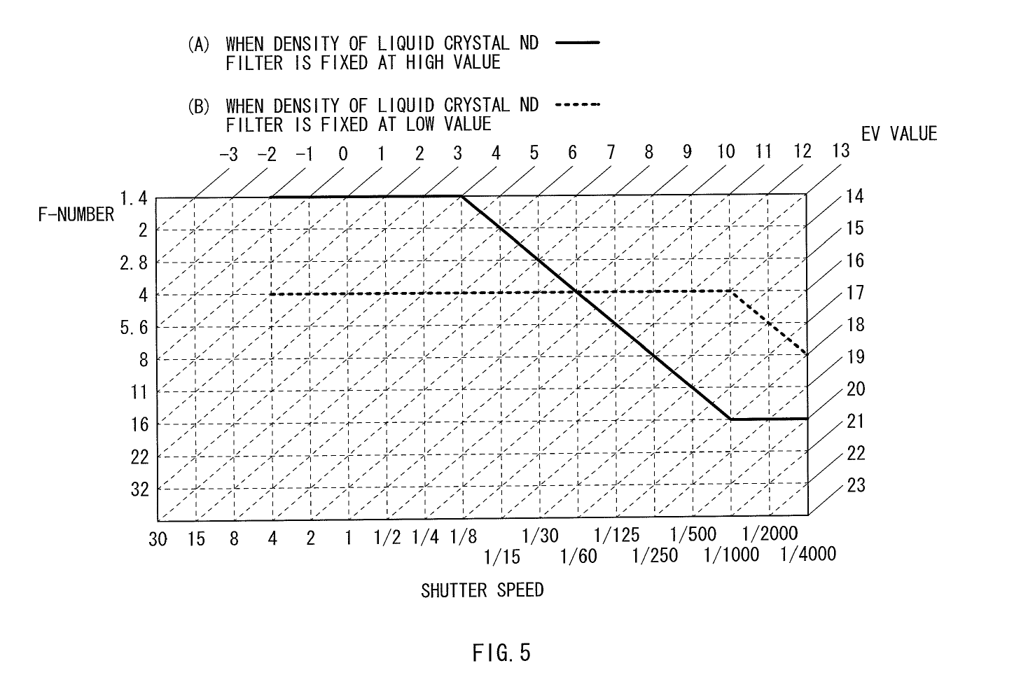

FIG. 5 illustrates a first specific example of a program diagram in AE control. In FIG. 5, a vertical axis represents aperture value (f-number) and a horizontal axis represents shutter speed, and oblique lines represent EV value (exposure value). This drawing illustrates an example in which the liquid crystal ND filter 4 is selectable between two states, i.e., a state where its density is relatively high (A) and a state where its density is relatively low (B). In the modes other than AWB mode, the liquid crystal ND filter 4 is fixed at one of the two states in the program diagram according to the density of the liquid crystal ND filter 4. In the AE control in the AWB mode, the liquid crystal ND filter 4 is appropriately switched from one of the two states in the program diagram to the other according to the density of the liquid crystal ND filter 4.

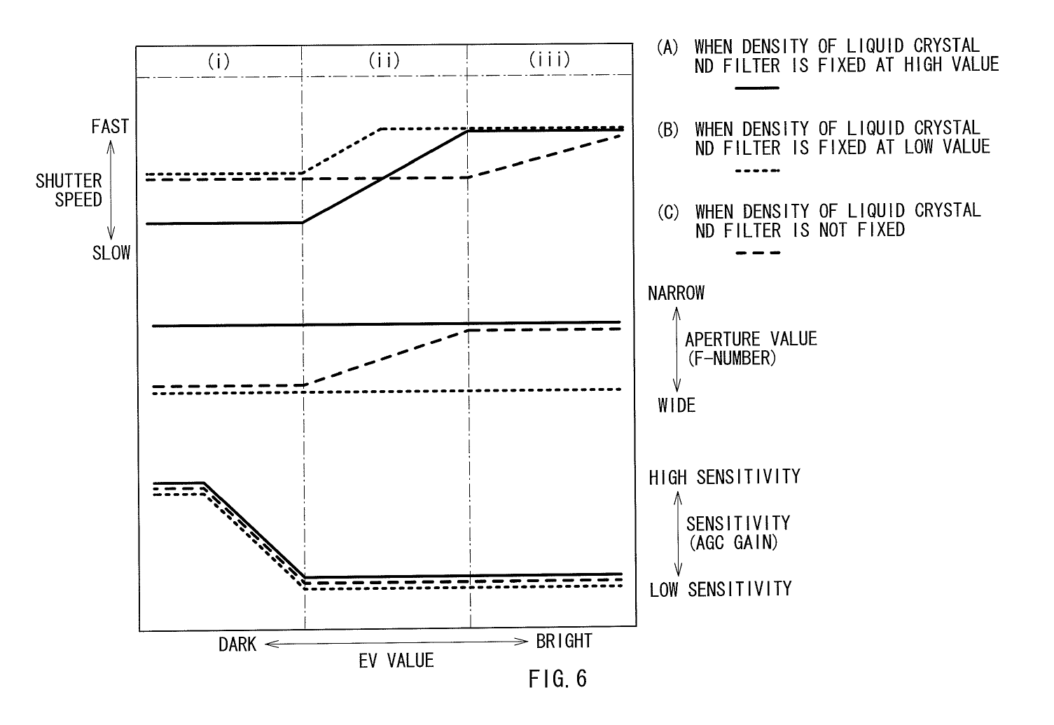

FIG. 6 illustrates a second specific example of a program diagram in the AE control. Three states, i.e., a state where the density of the liquid crystal ND filter 4 is fixed at a high value (A), a state where the density of the liquid crystal ND filter 4 is fixed at a low value (B), and a state where the density of the liquid crystal ND filter 4 is not fixed (C) are illustrated in this program diagram in FIG. 6. It is to be noted that AE control in a mode (the one-push WB mode or the fixed preset WB mode) other than the AWB mode is performed in the states (A) and (B) where the density of the liquid crystal ND filter 4 is fixed. AE control in the AWB mode is performed in the state (C) where the density of the liquid crystal ND filter 4 is not fixed. In FIG. 6, a horizontal axis represents EV value, an upper vertical axis represents shutter speed, a middle vertical axis represents aperture value (f-number), and a lower vertical axis represents sensitivity (the AGC gain in the preprocessing circuit 8). Control states in respective control regions (i), (ii), and (iii) according to brightness (the EV value) are as follows.

(i) AE control is performed through varying (following) sensitivity irrespective of the density state of the liquid crystal ND filter 4.

(ii) AE control is performed through varying the shutter speed when the density of the liquid crystal ND filter 4 is in the state (A) or (B). AE control is performed through varying the aperture value when the density of the liquid crystal ND filter 4 is in the state (C).

(iii) AE control reaches a limit when the density of the liquid crystal ND filter 4 is in the state (A) or (B). AE control is performed through varying the shutter speed when the density of the liquid crystal ND filter 4 is in the state (C).

### [5. Effects]

As described above, in the image pickup unit according to the embodiment, the light amount adjustment value by the liquid crystal ND filter 4 is controlled at a fixed value when white balance is adjusted without following variations in color temperature of the light source 1 (in the modes other than the AWB mode); therefore, a color balance shift due to discoloration of the liquid crystal ND filter 4 is suppressed.

### [6. Modifications]

The present disclosure is not limited to the above-described embodiment, and may be variously modified. For example, in the above-described embodiment, white balance adjustment is performed on respective color components of R, G, and B in the image signal; however, white balance adjustment may be performed on not only the color components of R, G, and B but also other color components.

Moreover, for example, in the above-described embodiment, the liquid crystal dimming device using the GH liquid crystal is described as an example; however, the disclosure is not limited thereto, and a liquid crystal dimming device using a liquid crystal other than the GH liquid crystal may be used, and a dimming device other than the liquid crystal dimming device may be used.

More specifically, as the dimming device other than the liquid crystal dimming device, the following types of dimming devices may be used. Examples of the dimming devices include a dimming device using a gel material used for thermochromism (practical example: a mug, a polymer sheet, and the like) or thermotropy, a dimming device using a photochromic material (practical example: sunglasses varying their color by ultraviolet light, and the like), a dimming device using a hydrogen gas or the like in gasochromism (practical example: window glass and the like), and a dimming device using WO₃ (tungsten oxide), Nb₂O₅ (niobium oxide), NiO (nickel oxide), Cr₂O₃ (chromium oxide) or the like in electrochromism (practical example: window glass and the like).

Moreover, signal processing (white balance control and the like) described in the above-described embodiment may be implemented by hardware (a circuit) or software (a program). In the case where the signal processing is implemented by software, the software is configured of programs allowing a computer (such as a microcomputer in an image pickup unit) to execute respective signal processing functions (a white balance control function and the like). Each of the programs may be installed in exclusive hardware in advance to be used, or may be installed on a general-purpose personal computer or the like from a network or a recording medium to be used.

For example, the present technology may have the following configurations.

(1) An image pickup unit including:

an image pickup device outputting an image signal based on incident object light;

a dimming device adjusting a light amount of object light incident to the image pickup device;

a color correction section adjusting color balance of the image signal; and

a control section controlling the color correction section to be switched from one of a first adjustment mode and a second adjustment mode to the other, the first adjustment mode automatically adjusting the color balance following variations in color temperature of a light source, the second adjustment mode adjusting the color balance without following variations in color temperature of the light source,

in which the control section controls a light amount adjustment value by the dimming device at a fixed value, when the color correction section is switched to the second adjustment mode.

(2) The image pickup unit according to (1), in which the dimming device is an ND filter allowing light transmittance to be electrically switched into any one of a plurality of modes.

(3) The image pickup unit according to (1) or (2), in which the control section controls, when the color correction section is switched into the second adjustment mode, the light amount adjustment value by the dimming device to be fixed at an adjustment value at the time of the mode switching.

(4) The image pickup unit according to (1) or (2), in which the control section controls the light amount adjustment value by the dimming device to be fixed at a predetermined adjustment value, when the color correction section is switched into the second adjustment mode.

(5) The image pickup unit according to any one of (1) to (4), in which the color correction section adjusts the color balance to be fixed at predetermined color balance in the second adjustment mode.

(6) The image pickup unit according to any one of (1) to (4), in which the color correction section adjusts color balance while shooting an image of a specific object, and then fixes the adjusted color balance in the second adjustment mode.

(7) The image pickup unit according to any one of (1) to (6), further including, in addition to the dimming device serving as a first exposure adjustment section performing exposure adjustment during image shooting, a second exposure adjustment section performing exposure adjustment during image shooting

in which exposure adjustment is performed with use of both the first exposure adjustment section and the second exposure adjustment section in the first adjustment mode, and

exposure adjustment is performed by the second exposure adjustment section in the second adjustment mode.

(8) A color correction method including:

adjusting, by a dimming device, a light amount of object light incident to an image pickup device;

adjusting, by a color correction section, color balance of an image signal output from the image pickup device; and

controlling the color correction section to be switched from one of a first adjustment mode and a second adjustment mode to the other, the first adjustment mode automatically adjusting the color balance following variations in color temperature of a light source, the second adjustment mode adjusting the color balance without following variations in color temperature of the light source,

in which in the controlling of the color correction section, a light amount adjustment value by the dimming device is controlled at a fixed value, when the color correction section is switched into the second adjustment mode.

(9) A color correction program adapted to be executed to implement a method, the method including:

adjusting, by a dimming device, a light amount of object light incident to an image pickup device;

adjusting, by a color correction section, color balance of an image signal output from the image pickup device; and

controlling the color correction section to be switched from one of a first adjustment mode and a second adjustment mode to the other, the first adjustment mode automatically adjusting the color balance following variations in color temperature of a light source, the second adjustment mode adjusting the color balance without following variations in color temperature of the light source,

in which in the controlling of the color correction section, a light amount adjustment value by the dimming device is controlled at a fixed value, when the color correction section is switched into the second adjustment mode.

The present disclosure contains subject matter related to that disclosed in Japanese Priority Patent Application No. 2012-009231 filed in the Japan Patent Office on Jan. 19, 2012, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. An image pickup unit comprising:
an image pickup device outputting an image signal based on incident object light;
a dimming device adjusting a light amount of object light incident to the image pickup device;
a color correction section adjusting color balance of the image signal; and
a control section controlling the color correction section to be switched from one of a first adjustment mode and a second adjustment mode to the other, the first adjustment mode automatically adjusting the color balance following variations in color temperature of a light source, the second adjustment mode adjusting the color balance without following variations in color temperature of the light source,
wherein the control section controls a light amount adjustment value by the dimming device at a fixed value, when the color correction section is switched to the second adjustment mode.

2. The image pickup unit according to claim 1, wherein the dimming device is an ND filter allowing light transmittance to be electrically switched into any one of a plurality of modes.

3. The image pickup unit according to claim 1, wherein the control section controls, when the color correction section is switched into the second adjustment mode, the light amount adjustment value by the dimming device to be fixed at an adjustment value at the time of the mode switching.

4. The image pickup unit according to claim 1, wherein the control section controls the light amount adjustment value by the dimming device to be fixed at a predetermined adjustment value, when the color correction section is switched into the second adjustment mode.

5. The image pickup unit according to claim 1, wherein the color correction section adjusts the color balance to be fixed at predetermined color balance in the second adjustment mode.

6. The image pickup unit according to claim 1, wherein the color correction section adjusts color balance while shooting an image of a specific object, and then fixes the adjusted color balance in the second adjustment mode.

7. The image pickup unit according to claim 1, further comprising, in addition to the dimming device serving as a first exposure adjustment section performing exposure adjustment during image shooting, a second exposure adjustment section performing exposure adjustment during image shooting,
wherein exposure adjustment is performed with use of both the first exposure adjustment section and the second exposure adjustment section in the first adjustment mode, and
exposure adjustment is performed by the second exposure adjustment section in the second adjustment mode.

8. A color correction method comprising:
adjusting, by a dimming device, a light amount of object light incident to an image pickup device;
adjusting, by a color correction section, color balance of an image signal output from the image pickup device; and
controlling the color correction section to be switched from one of a first adjustment mode and a second adjustment mode to the other, the first adjustment mode automatically adjusting the color balance following variations in color temperature of a light source, the second adjustment mode adjusting the color balance without following variations in color temperature of the light source,
wherein in the controlling of the color correction section, a light amount adjustment value by the dimming device is controlled at a fixed value, when the color correction section is switched into the second adjustment mode.

9. A color correction program adapted to be executed to implement a method, the method comprising:
adjusting, by a dimming device, a light amount of object light incident to an image pickup device;
adjusting, by a color correction section, color balance of an image signal output from the image pickup device; and
controlling the color correction section to be switched from one of a first adjustment mode and a second adjustment mode to the other, the first adjustment mode automatically adjusting the color balance following variations in color temperature of a light source, the second adjustment mode adjusting the color balance without following variations in color temperature of the light source,
wherein in the controlling of the color correction section, a light amount adjustment value by the dimming device is controlled at a fixed value, when the color correction section is switched into the second adjustment mode.
